(19) United States
(12) Patent Application Publication
(10) Pub. No.: US 2018/0151871 A1
(43) Pub. Date: May 31, 2018

(54) FABRICATION METHOD FOR A POROUS POSITIVE ELECTRODE FOR A LITHIUM-SULPHUR ELECTROCHEMICAL BATTERY

(71) Applicant: Commissariat à l'Énergie Atomique et aux Énergies Alternatives, Paris (FR)

(72) Inventors: Céline BARCHASZ, Fontaine (FR); Marco BOLLOLI, Grenoble (FR); Fabien CLAUDEL, Saint Martin D'Heres (FR); Rémi VINCENT, Grenoble (FR)

(21) Appl. No.: 15/823,078

(22) Filed: Nov. 27, 2017

(30) Foreign Application Priority Data
Nov. 28, 2016 (FR) 16 61583

(51) Int. Cl. H01M 4/1393; H01M 10/052; H01M 4/62

(52) U.S. Cl. CPC H01M 4/1393; H01M 2004/028; H01M 4/622; H01M 10/052

(57) ABSTRACT

The invention relates to a preparation method for a porous positive electrode deposited on a substrate for a lithium-sulphur battery, and which comprises the following steps: a) a step for the deposition onto a substrate of at least one layer of a first composition comprising at least one electrically-conductive inorganic carbon-containing additive, at least one polymer binder and at least one pore-forming agent; b) a step for the removal of the pore-forming agent(s) by sintering of the deposited layer or layers; c) a step c) a step for bringing the layer or layers obtained in b) into contact with a second composition comprising a sulphur-containing active material.

This application claims priority from French Patent Application No. 16 61583 filed on Nov. 28, 2016. The content of this application is incorporated herein by reference in its entirety.

### TECHNICAL FIELD

The present invention relates to a preparation method for a porous positive electrode for a lithium-sulphur electrochemical battery.

The general field of the invention may thus be defined as that of energy storage devices, in particular that of lithium electrochemical batteries, and yet more specifically of lithium-sulphur electrochemical batteries.

### STATE OF THE PRIOR ART

Energy storage devices are conventionally electrochemical batteries which operate on the principle of electrochemical cells capable of delivering an electric current due to the presence in each of them of an electrode pair (a positive and negative electrode respectively) separated by an electrolyte, where the electrodes comprise specific materials capable of reacting in accordance with an oxidation-reduction reaction, as a result of which electrons are produced at the source of the electric current and ions are produced which pass from one electrode to the other by means of an electrolyte.

The most commonly used batteries in current use are the following:

*Ni-MH batteries which use a metallic hydride and nickel oxyhydroxide as electrode materials;

*Ni—Cd batteries which use cadmium and nickel oxyhydroxide as electrode materials;

*Lead-Acid batteries which use lead and lead oxide PbO₂ as electrode materials; and

*lithium batteries, such as lithium-ion batteries, which conventionally use, entirely or in part, lithium-containing materials as electrode materials.

Because lithium is a particularly light solid element and has a particularly low electrochemical potential, lithium batteries have to a great extent replaced the other batteries mentioned above as a result of the continuous improvement in the performance of Li-ion batteries in terms of energy density. Lithium-ion batteries can indeed achieve energy densities per unit mass and per unit volume (which today may reach close to 300 Wh.kg⁻¹) which are significantly greater than those of Ni-MH and Ni—Cd batteries (which can range from 50 to 100 Wh.kg ⁻¹) and Lead-acid batteries (which can range from 30 to 35 Wh.kg⁻¹). Furthermore, Li-ion batteries can exhibit a nominal cell voltage which is greater than that for the other batteries (for example a nominal voltage of the order of 3.6 V for a cell which uses the LiCoO₂/graphite pair as electrode materials, as opposed to a nominal voltage of the order of 1.5 V for the other aforementioned batteries). These systems also exhibit a low self-discharge and a long service life (ranging, for example, from 500 to 1000 cycles).

Because of their intrinsic properties Li-ion batteries promise to be of particular interest in fields where endurance is a criterion of primary importance, as is the case in the fields of information technology, video, telephones, in transportation such as electric vehicles, hybrid vehicles, or in medical, aerospace and microelectronics fields. However, the level of performance achieved with lithium-ion battery technology has currently reached a ceiling.

A new battery technology based on lithium is currently emerging as a promising alternative. This is lithium/sulphur technology in which the positive electrode comprises elemental sulphur or a sulphur derivative, such as lithium sulphide or lithium polysulphide, as an active material.

The use of sulphur as the active material of a positive electrode is particularly attractive, since sulphur theoretically offers a very high specific capacity which may be 10 times greater than that obtained for conventional positive electrode materials (of the order of 1675 mAh/g instead of 140 mAh/g for LiCoO₂). Furthermore, sulphur is abundant on the planet, and as a result is characterised by low costs. Finally, it is of low toxicity. All of these qualities contribute to making it particularly attractive for the purpose of large-scale use, in particular for electric vehicles, even more so since lithium/sulphur batteries can achieve energy densities per unit mass which can range from 300 to 600 Wh.g⁻¹.

From a functional point of view, the reaction at the origin of the current production (that is, when the battery is in discharge mode) uses an oxidation reaction of the lithium at the negative electrode which produces electrons, which feed the external circuit to which the positive and negative electrodes are connected, and a reduction reaction of the sulphur at the positive electrode.

Thus, in explicit terms, in the discharge process the overall reaction is as follows:

S₈+16Li→8Li₂S

which is the sum of the sulphur reduction reaction at the positive electrode (S₈+16e⁻→8S²⁻) and of the lithium oxidation reaction at the negative electrode (Li→Li⁺₊e⁻).

It is to be understood that the reverse electrochemical reactions occur during the charging process.

As the above equation shows, the reaction involves an exchange of 16 electrons, which explains the high specific capacity of the sulphur (1675 mAh.g⁻¹).

From a mechanistic point of view, and without being bound by theory, in the initial state (that is, when the battery is in the fully-charged state), the active material, which is elemental sulphur, is present in the solid state in the positive electrode. During the course of reduction of the sulphur, that is during discharge, the cyclic sulphur molecules are reduced and form linear chains of lithium polysulphides, with the general formula Li₂Sₙ, where n can be from 2 to 8. Since the initial molecule is S₈, the first compounds formed are long-chain lithium polysulphides, such as Li₂S₈ or Li₂S₆. Since these lithium polysulphides are soluble in organic electrolytes, the first discharge step therefore involves the solubilisation of the active material in the electrolyte, and the production of long-chain lithium polysulphides in solution. Then, as the reduction of the sulphur takes place, the chain length of the polysulphides is gradually reduced, and compounds such as Li₂S₅, Li₂S₄ or Li₂S₂ are formed in solution. Finally, the reduction end-product is lithium sulphide (Li₂S) which is insoluble in organic electrolytes. Thus the last step in the sulphur reduction mechanism involves precipitation of the sulphur-containing active material.

This mechanism can be correlated with the discharge profile shown in FIG. 1, which shows a graph of the change in potential E (in V) as a function of the capacity C (in a.u.).

In this profile the first plateau can in effect be attributed to the formation of long chains of lithium polysulphides, whereas the second plateau corresponds to the reduction in the size of the sulphur-containing chains, up until passivation of the positive electrode occurs.

Nevertheless, lithium-sulphur batteries exhibit a certain number of drawbacks.

The first limitation is kinetic in nature, since sulphur is an insulating material. The sulphur is also soluble in the organic electrolytes used. Once dissolved it may contribute to causing corrosion of the lithium negative electrode, and is responsible for the significant degree of self-discharge of lithium-sulphur batteries.

The polysulphide intermediates are also soluble in the electrolyte and can react with the negative electrode. They therefore also promote battery self-discharge. Moreover, they are responsible for setting up a shuttle mechanism which occurs on charging, and which results in the deterioration of the battery performance, in particular in terms of the Coulombic efficiency. Finally, the discharge product Li₂S is itself insoluble in the electrolyte and an electronic insulator. It therefore precipitates at the end of discharge and passivates the surface of the electrodes which then become inactive. This means that the capacities obtained in practice may in general be well below the theoretical capacity, of the order of 300 to 1000 mAh.g⁻¹ (where the theoretical capacity is of the order of 1675 mAh.g⁻¹).

Thus there are improvements to be made concerning the architecture of the batteries, for example, at the sulphur-based positive electrode, the electrolyte, the separator and the negative electrode.

From a structural point of view a lithium/sulphur battery conventionally comprises at least one electrochemical cell comprising two electrodes based on different materials (a positive electrode which comprises elemental sulphur as its active material, and a negative electrode comprising metallic lithium as its active material), between which a liquid organic electrolyte is arranged.

As regards the positive electrode comprising sulphur, this is conventionally obtained by a method using coating onto a substrate which constitutes the current collector, to give an assembly made up of two parts formed by the current collector and the positive collector per se. More specifically, as shown in FIG. 2, first of all an ink is made comprising a solvent, the active material, a carbon-containing material (to improve the overall electron-conductivity of the electrode) and a binder (Part a) of FIG. 2). Secondly the ink is deposited onto a substrate which is intended to form the current collector, which is in general a metal sheet (such as an aluminium strip) (Part b) of FIG. 2). After evaporation of the solvent and drying, an electrode comprising sulphur deposited on a current collector is thus obtained (Part c) of FIG. 2), where the resulting assembly is then incorporated into a cell comprising a separator impregnated with organic liquid electrolyte, a negative electrode, where the negative electrode and the positive electrode are arranged on either side of the separator. The percentage of sulphur in the electrode is generally high, generally from 50 to 90% and preferably above 70% by mass, so as to obtain batteries with high energy-densities.

The discharge mechanism for a lithium-sulphur battery which uses such a positive electrode first of all involves a step for dissolution of the active material, which results in the initial structure of the porous electrode collapsing, due to the high percentage of sulphur in the electrode. After the sulphur dissolves, the porosity of the electrode is such that the structure cannot be supported and collapses. The available electrode surface area is therefore reduced and grains of material, or of carbon/binder composite, may break free of the support formed by the current collector. This damage, which thus results in a loss of active surface area, proves to be critical at the end of discharge, since the species formed (Li₂S₂, Li₂S, etc.) are both highly insulating and insoluble in the organic electrolyte. Consequently they precipitate at the positive electrode and are responsible for gradual passivation of the latter. Since the thickness of the deposited material is limited to a few nanometres (Li₂S is insulating and therefore passivating), the deposition of a significant quantity of active material therefore depends on the available electrode conductive specific surface area.

Furthermore the final discharge compound Li₂S occupies twice the volume of the sulphur, which may also contribute to the positive electrode structure breaking down into powder at the end of discharge. In conclusion, the solution/precipitation cycles of the active material which are inherent in the discharge mechanism are therefore responsible for the low capacity returned in practice and for the poor cycling behaviour of lithium-sulphur batteries.

In order to try to overcome these problems associated with the de-structuring of the positive electrodes, manipulation of the porosity of said electrodes has been proposed, such that an active surface area suitable for the electrochemical reaction is obtained (for example by means of micro-porosity) so that electrolyte penetration within the electrode and the deposition of larger-sized particles is obtained, without any de-structuring effects on the electrode and blocking up of the electrode (for example through macro-porosity). Thus as shown in FIG. 3, which schematically illustrates the methods of the prior art, a composition is first of all prepared which comprises an active sulphur-containing material, a carbon-containing additive, a polymer binder and a pore-forming agent (part a) of FIG. 3). The composition is then deposited on a substrate (part b) of FIG. 3), then dried (part c) of FIG. 3) and finally the pore-forming agent is removed (part d) of FIG. 3). More specifically, in U.S. 2015/0171416, the manufacture of a positive electrode is proposed by the formation of at least one layer of a composition on an electron-conducting substrate, this layer of a composition comprising a binding agent, an active material, if necessary, and a pore-forming agent, followed by drying of the layer thus deposited and removal of the pore-forming agent by washing with a solvent. This removal step by washing may nevertheless result in a partial removal of other ingredients, as well as in de-structuring of the deposited layer.

In the light of the existing situation, the authors of the present invention therefore proposed to develop a new procedure for the preparation of a porous positive electrode for a lithium-sulphur battery, wherein the formation of the porosity does not result in unwanted de-structuring and partial removal of its ingredients.

### DESCRIPTION OF THE INVENTION

Thus the invention relates to a preparation method for a porous positive electrode deposited on a substrate for a lithium-sulphur battery, and which comprises the following steps:

a) a step for the deposition onto a substrate of at least one layer of a first composition comprising at least one electrically-conductive inorganic carbon-containing additive, at least one polymer binder and at least one pore-forming agent;

b) a step for the removal of the pore-forming agent(s) by sintering of the deposited layer or layers;

c) a step for bringing the layers obtained in b) into contact with a second composition comprising a sulphur-containing active material.

By implementing such a method, the drawbacks associated with the removal of the pore-forming agent or agents by washing with an organic solvent are overcome, and in particular the use of sintering for the removal of the pore-forming agent or agents concurrently ensures consolidation of the deposited layer, unlike treatment with washing, which contributes instead to the de-structuring of the deposited layer.

The first composition deposited on the substrate in the form of one or more layers comprises at least one electrically-conductive inorganic carbon-containing additive, at least one polymer binder and at least one pore-forming agent and is therefore advantageously devoid of sulphur-containing active material.

As regards the electrically-conductive inorganic carbon-containing additives, they may be chosen from amongst carbon fibres, carbon powders and mixtures of these.

Crushed carbon fibres, carbon fibres obtained in the vapour phase and mixtures of these could be cited by way of examples of carbon fibres.

Crushed carbon fibres may in particular have a length of from 100 μm to 1 mm.

The carbon fibres obtained in the vapour phase may be those supplied under the VGCF® brand.

Advantageously the carbon fibres used have a length which is less than that of fibres commonly used in conventional methods to make woven or non-woven carbon materials (whose fibres have a length of the order of a few mm). They allow the mechanical strength to be adjusted and ensure electron percolation within the structure.

The carbon powders may more specifically correspond to carbon-black, such as the carbon-blacks supplied under the trade names Ketjenblack® (AzkoNobel), Vulcan® (Cabot), Super-P® (Timcal).

Carbon powders and if appropriate carbon fibres obtained in the vapour phase improve the electron conductivity and are responsible for the morphology of the electron percolation network.

The polymer binders may be, for example:

*polymer binders belonging to the category of hydrophilic polymers, such as:

cellulose polymers, such as carboxymethylcellulose (known by the abbreviation CMC), methylcellulose (known by the abbreviation MC);

binders belonging to the vinyl polymer category, such as poly(vinyl alcohol) (known by the abbreviation PVA);

*binders belonging to the hydrophobic polymer category, such as fluorinated ethylene polymers, such as polytetrafluoroethylene (known by the abbreviation PTFE); and

*mixtures of these.

The polymer binders may fulfil several roles:

they increase the cohesion between the various ingredients of the structure and in particular the carbon-containing additives;

they are used to control viscosity in the composition or compositions.

More specifically, when PTFE is involved, it can act as a film-forming agent and ensure the mechanical strength of the final structure.

As regards the pore-forming agent, it is pointed out that this is, more precisely, a pore-forming agent that is decomposed by heat, that is, it is any chemical compound that loses its structural integrity due to the effect of heat (as it happens, here, at the sintering temperature), whatever the mechanism by which this loss of integrity is achieved may be and irrespective of the nature and physical form of the end-products that it eventually forms (solid, liquid or gases).

By way of examples, it may be a compound chosen from:

compounds in the form of salts, such as chloride salts (such as sodium chloride, potassium chloride), acetate salts (such as barium acetate);

organic compounds such as azodicarbonamide compounds (supplied under the name of AZB®, phthalate compounds such as di-n-butyl phthalate.

The first composition may also comprise at least one surfactant (such as those supplied under the SDS®, Triton® brands)

Surfactants improve the dispersion of the inorganic carbon-containing additive particles.

A first specific composition may be a composition comprising:

from 15% to 65% by mass for carbon fibres, if relevant;

from 15% to 65% by mass for carbon powders;

from 10 to 20% by mass for the polymer binder when this is a hydrophobic polymer binder;

from 10 to 15% by mass for the polymer binder when this is a hydrophilic polymer binder;

from 5 to 20% by mass for the pore-forming agent;

at most 2% by mass for the surfactant, if relevant;

where the percentages by mass are expressed relative to the total mass of the ingredients of the first composition.

The support whereupon this first composition is deposited in the form of one or more layers is advantageously a current collector support, for example, a metal support and more specifically a support which takes the form of a metal sheet made, for example, of copper or of aluminium.

This first composition may be deposited by various techniques, such as:

dip-coating;

spin-coating;

laminar-flow-coating or meniscus coating;

spray-coating;

roll-to-roll process;

paint coating;

screen printing; or

techniques which use a horizontal knife for deposition (known as “tape-coating”).

The method of the invention may comprise, before step a) is implemented, a step for preparation of the first composition, said preparation comprising an operation for bringing the ingredients of said first composition (electrically-conductive inorganic carbon-containing additive(s), polymer binder(s), pore-forming agent(s), any surfactant(s)) into contact, followed by an operation for dispersion of the composition using a blender.

After step a) and before step b), the method of the invention may comprise a drying step, with the aim of removing volatile species and fixing the ingredients of the first composition on the support. This drying step can be carried out at a temperature of up to 120° C., for example at 80° C. in air.

Once step a) has been carried out and any drying step implemented, the method of the invention comprises a step for the elimination of the pore-forming agent or agents by sintering of the deposited layer or layers; that is, heat treatment carried out at a temperature and over a time period that is effective for achieving consolidation of the ingredients of the first composition, whilst allowing the removal of the pore-forming agent or agents by degradation of the latter.

By way of an example, sintering may be carried out in air at a temperature greater by at least 20% than the fusion temperature of the polymer binder or binders and which has, as its upper limit, the fusion temperature of the substrate, over a suitable time period which depends on the temperature used. By way of an example, a temperature of 350° C. for 30 minutes may be used for sintering of a composition containing a binder of the polytetrafluoroethylene type.

Once step b) has been carried out, the resulting porosity must advantageously be maintained to receive the second composition during the course of step c). Also, between step b) and step c), the method does not comprise, advantageously, a step for reducing the porosity resulting from the implementation of the step b), such as a calendaring process step.

After step b) the method comprises a step for bringing the layer or layers obtained in b) into contact with a second composition comprising a sulphur-containing active material.

This step can take place directly after step b) and before the electrode is put in place in a lithium-sulphur battery (so-called first alternative) or may be implemented after the electrode is incorporated in a lithium-sulphur battery and the latter brought into operation (so-called second alternative), in which case the second composition will correspond to the electrolyte comprising, moreover, the sulphur-containing active material.

According to the first alternative, the second composition comprises a sulphur-containing active material and may moreover comprise at least one electrically-conductive inorganic carbon-containing additive and at least one polymer binder.

The sulphur-containing active material may be elemental sulphur (S₈) or lithium disulphide (Li₂S), said sulphur-containing active material may be present in the second composition at a concentration ranging from 50 to 85% by mass relative to the total mass of the second composition, for example, at a concentration of 80%.

The electrically-conductive inorganic carbon-containing additive may be a carbon-black powder, which may be present in the second composition at a concentration of from 10 to 20% by mass relative to the total mass of the composition, for example at a concentration of 10%.

As for the binder, this may be chosen from polymer binders belonging to the cellulosic polymer category, such as carboxymethylcellulose (known by the abbreviation CMC), methylcellulose (known by the abbreviation MC).

This may be present at a concentration from 10 to 20% by mass relative to the total mass of the second composition, for example, a concentration of 10%.

The second composition may be deposited according to one of the techniques stated above in relation to the first composition.

Once step c) has been carried out, the method of the invention may undergo a drying step, with the aim of removing volatile species and fixing the ingredients of the second composition. This drying step may be carried out at a temperature that is compatible with the sulphur-containing active material, such as elemental sulphur for example, ranging from ambient temperature to 100° C. and more specifically at a temperature of 80° C. in air.

According to the second alternative, the second composition corresponds to an electrolyte used in the lithium-sulphur battery, said electrolyte comprising amongst other things the sulphur-containing active material, which corresponds to a battery operating in accordance with a catholyte type configuration. The sulphur-containing active material is advantageously a lithium polysulphide compound of formula Li₂S, where n is an integer from 2 to 8.

This compound thus forms the source of sulphur for the positive electrode.

In this case the amount of lithium polysulphide compound introduced in the electrolyte is chosen depending on the specific surface area of the product from step b) of the method of the invention, the latter dictating the amount of active material that it is possible to deposit. For example, the lithium polysulphide compound may be dissolved in the electrolyte at a concentration ranging from 0.25 mol.L⁻¹ to the saturation concentration.

Moreover the electrolyte serving as the second composition conventionally comprises at least one organic solvent and at least one lithium salt.

The organic solvent or solvents may be, for example, a solvent comprising one or more ether, nitrile, sulphone and/or carbonate functions with, for example, a carbon chain which may comprise from 1 to 10 carbon atoms.

The following may be cited by way of examples of solvents which comprise a carbonate function:

cyclic carbonate solvents, such as ethylene carbonate (represented by the abbreviation EC), propylene carbonate (represented by the abbreviation PC);

linear carbonate solvents, such as diethyl carbonate (represented by the abbreviation DEC), dimethyl carbonate (represented by the abbreviation DMC), ethylmethyl carbonate (represented by the abbreviation EMC).

The following could be cited by way of examples of solvents comprising an ether function: ether solvents, such as 1,3-dioxolane (represented by the abbreviation DIOX), tetrahydrofuran (represented by the abbreviation THF), 1,2-dimethoxyethane (represented by the abbreviation DME), or an ether of general formula CH₃O—[CH₂CH₂O]ₙ—OCH₃ (where n is an integer from 1 to 10), such as tetraethyleneglycol dimethylether (represented by the abbreviation TEGDME) and mixtures of these.

Preferably the organic solvent is an ether solvent or a mixture of ether solvents.

The lithium salt may be chosen from the group made up of LiPF₆, LiClO₄, LiBF₄, LiAsF₆, Lil, LiNO₃ LiR_{f}SO₃ (where R_{f} represents a perfluoroalkyl group comprising 1 to 8 carbon atoms), LiN(CF₃SO₂)₂ (also known as lithium bis[(trifluoromethyl)sulfonyl]imide represented by the abbreviation LiTFSI), LiN(C₂F₅SO₂)₂ (also known as lithium bis[(perfluoroethyl)sulfonyl]imide represented by the abbreviation LiBETI), LiCH₃SO₃, LiB(C₂O₄)₂ (also known as lithium bis(oxalato)borate or LiBOB) and mixtures of these, with preference given to a LiTFSI/LiNO₃mixture.

The lithium salt may be present in the electrolyte at a concentration ranging from 0.25M to 2M, for example 1M.

By way of an example, FIG. 4 shows an embodiment of the method of the invention in which:

part a) of the figure shows the preparation of a first composition comprising an inorganic carbon-containing additive, a polymer binder and a pore-forming agent;

part b) of the figure shows the deposition of the first composition onto a substrate;

part c) of the figure shows the step for drying of the first composition;

part d) of the figure shows the step for removal of the pore-forming agent; and

part e) of the figure shows the step for bringing a second composition comprising the sulphur-containing active material into contact.

The positive electrodes deposited on a substrate obtained according to the method of the invention are, because of the ingredients they contain, structures capable of fulfilling both the role of positive electrode and the role of current collector.

The positive electrodes according to the method of the invention are intended to be assembled in a lithium-sulphur battery comprising at least one cell which comprises:

a positive electrode obtained according to the method of the invention as defined above;

a negative electrode; and

an electrolyte which conducts lithium ions, arranged between said structure and said negative electrode.

The following definitions should be pointed out.

The term positive electrode conventionally relates, both above and below, to the electrode serving as the cathode when the battery is passing current (that is, when it is in the process of discharging) and which serves as the anode when the battery is in the process of charging.

The term negative electrode conventionally relates, both above and below, to the electrode serving as the anode, when the battery is passing current (that is, when it is in the process of discharging) and which serves as the cathode when the battery is in the process of charging.

The negative electrode may be self-supporting (that is, it does not need to rest against a support, such as a current collector support) or may comprise, preferably, a current collector substrate whereupon at least the active material of the negative electrode is placed, where this active material advantageously may be metallic lithium.

The current collector substrate may be made of a metallic material (composed of a single metallic element or of an alloy of a metallic element and another element), which takes, for example, the form of a plate or strip, where a specific example of a current collector substrate may be a stainless steel or copper plate. The current collector substrate may also be made of a carbon-containing material.

The electrolyte is an electrolyte which conducts lithium ions, where this electrolyte may be in particular a liquid electrolyte comprising at least an organic solvent and at least one lithium salt, such as defined above.

Moreover when the battery is operating in accordance with a catholyte configuration, the electrolyte may comprise at least one lithium polysulphide compound of formula Li₂S, where n is an integer from 2 to 8, as defined above.

In lithium-sulphur batteries, the above-mentioned liquid electrolyte may, in the electrochemical cells of the lithium-sulphur batteries, impregnate a separator which is arranged between the positive electrode and the negative electrode of the electrochemical cell.

This separator may be made of a porous material, such as a polymer material, capable of holding the liquid electrolyte in its pores.

The electrolyte may also be a gel electrolyte, which in this case represents an electrolyte containing an organic solvent and a lithium salt, similar to those described above, impregnating a porous matrix which swells by absorbing the electrolyte. Such a matrix may be a polyoxyethylene (known by the abbreviation POE), a polyacrylonitrile (known by the abbreviation PAN), a polymethyl methacrylate (known by the abbreviation PMMA), polyvinylidene fluoride (known by the abbreviation PVDF) and their derivatives.

The invention will now be described with reference to the specific embodiments defined below, with reference to the appended figures.

### BRIEF DESCRIPTION OF DRAWINGS

FIG. 1 is a graph showing the change in potential E (in V) as a function of the capacity C (in a.u.).

FIG. 2 is a method flow-chart showing the preparation of a positive electrode in accordance with the state of the art.

FIG. 3 is a method flow-chart showing another method of preparation of a positive electrode according to the state of the art.

FIG. 4 is a method flow-chart showing a method of preparation of a positive electrode according to the method of the invention.

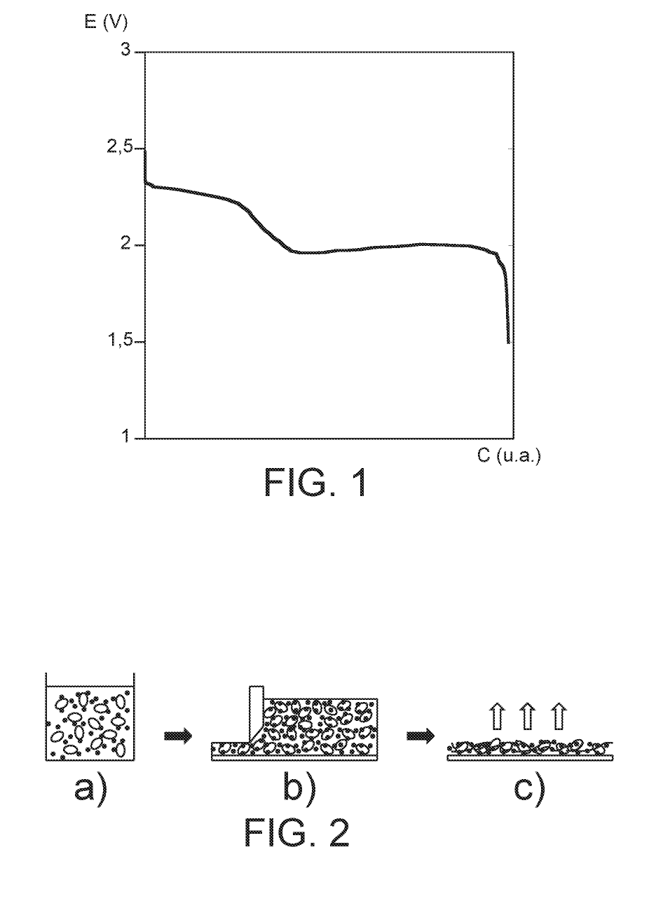

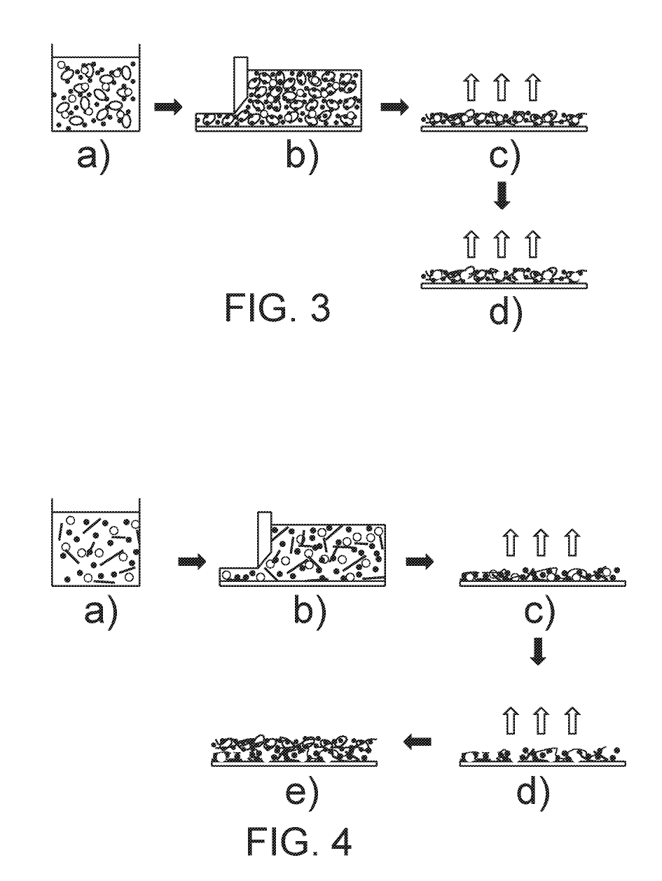

### DETAILED DESCRIPTION OF PARTICULAR EMBODIMENTS

### EXAMPLE 1

The present example shows the preparation of a positive electrode obtained according to the method in accordance with the invention.

To achieve this, a strip of aluminium acting as a current collector is coated with a first composition comprising the following ingredients:

0.75 g of Vulcan® carbon-black powder (that is 35.61% by dry mass after sintering);

0.75 g of VGCF® carbon fibre obtained in the vapour phase (that is 35.61% by dry mass after sintering);

0.2 g of an azodicarbonamide compound AZB® (0% by dry mass after sintering);

0.28 g of Triton X-100 surfactant (0% by dry mass after sintering); and

0.25 g of polytetrafluoroethylene (PTFE) (21.58% by dry mass after sintering);

0.25 g of carboxymethylcellulose (CMC) (7.19% by dry mass after sintering).

The dry extract (namely the percentage per unit mass of dry product in the composition) is 10.63%.

The composition thus coated undergoes sintering at 350° C. for 30 minutes.

The resulting product is then coated, by using a comb, with a second composition which comprises:

8 g of elemental sulphur (79.92% by dry mass);

1 g of Super P® (9.99% by dry mass); and

50 g of carboxymethylcellulose (10.09% by dry mass).

The entire assembly is then dried at 80° C. in air for 10 minutes.

The result is an electrode with a mass per unit area of carbon of 8.480 mg/cm² of electrode and a mass per unit area of sulphur of 2.845 mg/cm² of electrode.

### COMPARATIVE EXAMPLE 1

The present example shows the preparation of a positive electrode obtained according to a method not in accordance with the invention.

To achieve this, a strip of aluminium acting as a current collector is coated with a first composition comprising the following ingredients:

8 g of elemental sulphur (79.92% by dry mass);

1 g of Super P® (9.99% by dry mass); and

50 g of carboxymethylcellulose (10.09% by dry mass).

The entire assembly is then dried at 55° C. in air for 1 hour.

The result is an electrode with a mass per unit area of sulphur of 2.77 mg/cm² of electrode.

### EXAMPLE 2

In this example, the positive electrodes obtained in the preceding examples were tested in batteries in order to determine the capacities per unit mass on discharge.

The batteries used were button batteries designed in the following manner.

Disks of diameter 14 mm were cut out of the positive electrodes obtained in examples 1 and comparative 1 described above, and dried under vacuum (20 torr) at 80° C. for 48 hours. They were then incorporated as a positive electrode into a “button battery” type battery (CR2032) constructed in this manner:

a negative electrode made of lithium of thickness 130 μm, cut out to a diameter of 16 mm and deposited on a disk of stainless steel acting as a current collector;

a positive electrode deposited on a collector made of aluminium;

a Celgard® 2400 separator, impregnated with a liquid electrolyte based on LiTFSI (1 mol.L⁻¹), LiNO₃ (0.1 mol.L⁻¹) salt in solution in a 50/50 by volume TEGDME (tetraethylene glycol dimethylether)—DIOX (Dioxolane) mixture.

The batteries obtained underwent galvanostatic cycling tests at C/20 to determine the discharge capacities per unit mass per gram of sulphur after the 5^{th} cycle, with the results obtained shown in the table below.

| | Discharge capacity- |
|---|---|
| Positive electrode | 5^{th} Cycle (mAh/g) |
| Example 1 | 682.4 |
| Comparative example 1 | 300 |

This shows that the discharge capacity per unit mass of the positive electrodes prepared in accordance with the method of the invention has more than doubled compared with the discharge capacity per unit mass of the positive electrode of comparative example 1.

1. Preparation method for a porous positive electrode deposited on a substrate for a lithium-sulphur battery, comprising the following steps:
a) a step for the deposition onto a substrate of at least one layer of a first composition comprising at least one electrically-conductive inorganic carbon-containing additive, at least one polymer binder and at least one pore-forming agent;
b) a step for the removal of the pore-forming agent(s) by sintering of the deposited layer or layers;
c) a step for bringing the layers obtained in b) into contact with a second composition comprising a sulphur-containing active material.

2. Method according to claim 1, wherein the electrically-conductive inorganic carbon-containing additive or additives are chosen from amongst carbon fibres, carbon powders and mixtures of these.

3. Method according to claim 1, wherein the polymer binder or binders are chosen from:
*polymer binders belonging to the category of hydrophilic polymers, such as:
cellulosic polymers, such as carboxymethylcellulose, methylcellulose;
binders belonging to the vinyl polymer category, such as poly(vinyl alcohol);
*binders belonging to the hydrophobic polymer category, such as fluorinated ethylene polymers, such as polytetrafluoroethylene (known by the abbreviation PTFE); and
*mixtures of these.

4. Method according to claim 1, wherein the pore-forming agents are chosen from:
compounds in the form of salts, such as chloride salts (such as sodium chloride, potassium chloride), acetate salts (such as barium acetate);
organic compounds, such as azodicarbonamide compounds, phthalate compounds.

5. Method according to claim 1, wherein the support is a current collector support.

6. Method according to claim 1, wherein the support is a metallic support.

7. Method according to claim 1, wherein the step c) occurs directly after step b) and before the electrode is put in place in a lithium-sulphur battery (so-called first alternative) or is put in place after incorporation of the electrode in a lithium sulphur battery and operation of the latter.

8. Method according to claim 7 wherein, according to the first alternative, the second composition moreover comprises at least one electrically-conductive inorganic carbon-containing additive and at least one polymer binder.

9. Method according to claim 8, wherein the sulphur-containing active material is elemental sulphur (S₈) or lithium disulphide (Li₂S).

10. Method according to claim 7 wherein, according to the second alternative, the second composition corresponds to an electrolyte used in a lithium-sulphur battery.

11. Method according to claim 10, wherein the sulphur-containing active material is a lithium polysulphide compound of formula Li₂S, where n is an integer from 2 to 8.

12. Method according to claim 10, wherein the second composition moreover comprises at least one organic solvent and at least one lithium salt.

13. Method according to claim 1, wherein the first composition is devoid of sulphur-containing active material.
